(19) United States
(12) Patent Application Publication
(10) Pub. No.: US 2005/0206755 A1
(43) Pub. Date: Sep. 22, 2005

(54) Solid-state imaging device

(75) Inventors: Daisuke Yokoyama, Kanagawa (JP); Toshiaki Fukunaga, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/080,966

(22) Filed: Mar. 16, 2005

(30) Foreign Application Priority Data
Mar. 17, 2004 (JP) P2004-076069

(51) Int. Cl. H04N 5/335

(52) U.S. Cl. 348/272

(57) ABSTRACT

A solid-state imaging device provided by stacking a photoelectric conversion element is provided with a semiconductor substrate having a signal readout circuit and a photoelectric conversion element stacked on the semiconductor substrate, an incident light is photoelectrically converted to a signal according to the light quantity by the photoelectric conversion element and read out by the signal readout circuit, and the photoelectric conversion element is composed of a first deposition layer comprising a p-conductive quantum dot and an i-conductive quantum dot, and a second deposition layer comprising an n-conductive quantum dot and an i-conductive quantum dot

This application is based on Japanese Patent application JP 2004-076069, filed Mar. 17, 2004, the entire content of which is hereby incorporated by reference. This claim for priority benefit is being filed concurrently with the filing of this application.

### BACKGROUND OF THE INVENTION

1. Technical Field of the Invention

The present invention relates to a imaging device provided by stacking a photoelectric conversion element on a semiconductor substrate having a signal readout circuit.

2. Description of the Related Art

One prototype of the solid-state imaging devices is a solid-state imaging device described in JP-A-58-103165. This solid-state imaging device comprises a semiconductor substrate and 3 photosensitive layers stacked thereon, and electric signals for red (R), green (G), and blue (B) are detected by each of the photosensitive layers and read out by an MOS circuit formed on the semiconductor substrate.

After the solid-state imaging device having such a structure has been proposed, remarkable progress has been made in CCD image sensors and CMOS image sensors, which comprise a large number of photoreceivers (photodiodes) integrated on a semiconductor substrate and color filters for red (R), green (G), and blue (B) stacked on each photoreceiver. Nowadays digital still cameras can be equipped with an image sensor having several million photoreceivers (pixels) on each chip.

However, technologies for the CCD and CMOS image sensors have progressed nearly to the end. The photoreceiver has an aperture size of approximately 2 μm close to wavelength order of incident light, thereby facing the problem of poor production yield.

Further, the upper limit of photoelectric charges accumulated in the miniaturized photoreceiver is only approximately 3,000 electrons, so that it is difficult to represent 256 tones clearly. Thus, it can hardly expect to further improve the image qualities and sensitivities of the related art CCD and CMOS image sensors.

Therefore, the solid-state imaging device proposed in JP-A-58-103165 attracts much attention in view of overcoming the problems, and then image sensors of Japanese Patent No. 3,405,099 and JP-A-2002-83946 are proposed.

The image sensor described in Japanese Patent No. 3,405,099 is such that ultrafine silicon particles are dispersed in a medium to form photoelectric conversion layers, 3 photoelectric conversion layers having different ultrafine particle sizes are stacked on a semiconductor substrate, and electric signals of red, green, and blue are generated according to light quantities respectively in the photoelectric conversion layers.

The image sensor described in JP-A-2002-83946 has the same structure where 3 nanosilicon layers having different particle sizes are stacked on a semiconductor substrate, and electric signals of red, green, and blue are detected in each of the nanosilicon layers and are read out to an accumulation diode formed on the semiconductor substrate.

In the case of using the ultrafine silicon particles in the photoelectric conversion layers, electron-hole pairs generated by light absorption are recombined on surfaces of the ultrafine particles in a short period of time. Thus, it is not easy to extract the charges before the recombination, thereby resulting in poor imaging performances.

To put the solid-state imaging devices into practical use, problems of materials and structures of the photoelectric conversion elements have to be solved.

### SUMMARY OF THE INVENTION

An object of the present invention is to provide a solid-state imaging device provided by stacking a photoelectric conversion element, from which photoelectric charges can be extracted efficiently.

The solid-state imaging device of the present invention comprises a semiconductor substrate having a signal readout circuit and a photoelectric conversion element stacked on the semiconductor substrate, an incident light is photoelectrically converted to a signal according to the light quantity by the photoelectric conversion element and read out by the signal readout circuit, and the photoelectric conversion element comprises a first deposition layer comprising a p-conductive quantum dot and an i-conductive quantum dot, and a second deposition layer comprising an n-conductive quantum dot and an i-conductive quantum dot.

In this constitution, the photoelectric conversion element has a macroscopic p-n junction and an electric potential gradient, whereby photoelectric charges generated by light incidence can be easily extracted.

In the solid-state imaging device of the invention, a third deposition layer comprising an i-conductive quantum dot without the p-conductive quantum dot and the n-conductive quantum dot may be disposed between the first deposition layer and the second deposition layer.

In this constitution, the photoelectric conversion element has a macroscopic p-i-n junction, whereby the photoelectric charges generated by light incidence can be more easily extracted due to an electric potential gradient formed in the i-layer.

In the solid-state imaging device of the invention, each of the quantum dots may comprise a core of an ultrafine semiconductor particle and a material covering the core, the optical bandgap energy of the material being larger than that of the ultrafine semiconductor particle.

In this constitution, electron-hole pairs, which are generated by light incidence into the ultrafine semiconductor particle, are prevented from recombining on surfaces of the particles, whereby the photoelectric charges can be further easily extracted.

In the solid-state imaging device of the invention, the ultrafine semiconductor particle may comprise CdSe, and the material for covering CdSe may be ZnS.

In this constitution, the photoelectric conversion element can be easily produced.

In the solid-state imaging device of the invention, the ultrafine semiconductor particle may comprise ZnTe, and the material for covering ZnTe may be ZnS.

In this constitution, the photoelectric conversion element can be easily produced.

In the solid-state imaging device of the invention, the ultrafine semiconductor particle may comprise InN, and the material for covering InN may be GaN.

Also in this constitution, the photoelectric conversion element can be easily produced.

In the solid-state imaging device of the invention, 3 photoelectric conversion elements may be sandwiched between 2 transparent electrode films respectively and stacked with intermediate transparent insulating films.

In this constitution, a color image can be picked up.

In the solid-state imaging device of the invention, the average diameter of the quantum dots in each of the photoelectric conversion elements may be determined such that, among the 3 photoelectric conversion elements, a first photoelectric conversion element has an absorption maximum within a wavelength range of 420 to 500 nm, a second photoelectric conversion element has an absorption maximum within a wavelength range of 500 to 580 nm, and a third photoelectric conversion element has an absorption maximum within a wavelength range of 580 to 660 nm.

In this constitution, image data can be separated and extracted by the three primary colors of red (R), green (G), and blue (B).

In the solid-state imaging device of the invention, 4 photoelectric conversion elements may be sandwiched between 2 transparent electrode films respectively and stacked with intermediate transparent insulating films.

In this constitution, the signal can be subjected to various processings to capture a color image with excellent color reproducibility.

In the solid-state imaging device of the invention, the average diameter of the quantum dots in each of the photoelectric conversion elements may be determined such that, among the 4 photoelectric conversion elements, a first photoelectric conversion element has an absorption maximum within a wavelength range of 420 to 480 nm, a second photoelectric conversion element has an absorption maximum within a wavelength range of 480 to 520 nm, a third photoelectric conversion element has an absorption maximum within a wavelength range of 520 to 580 nm, and a fourth photoelectric conversion element has an absorption maximum within a wavelength range of 580 to 660 nm.

In this constitution, a color image can be produced according to human visibility.

According to the present invention, there is provided the solid-state imaging device provided by stacking a photoelectric conversion element, from which the photoelectric charges (signal charges) can be extracted efficiently.

In addition, the solid-state imaging device according to the present invention can be used instead of the related art CCD and CMOS image sensors, and is advantageous in that each pixel can be increased in size to improve the sensitivity. The solid-state imaging device is useful for digital cameras, etc.

### BRIEF DESCRIPTION OF THE DRAWINGS

FIG. 1 is a schematic cross-sectional view showing 1 pixel of a solid-state imaging device provided by stacking 3 photoelectric conversion elements according to an embodiment of the present invention.

FIG. 2 is a schematic cross-sectional view showing 1 pixel of a solid-state imaging device provided by stacking 4 photoelectric conversion elements according to an embodiment of the invention.

FIG. 3 is a graph showing a human visibility.

FIG. 4 is a schematic circuit diagram of signal readout MOS circuits.

FIG. 5 is a schematic cross-sectional view showing a photoelectric conversion element according to an embodiment of the invention.

FIG. 6 is a schematic view showing an energy band of the photoelectric conversion element of FIG. 5.

### DETAILED DESCRIPTION OF THE INVENTION

An embodiment of the present invention is described below with reference to drawings.

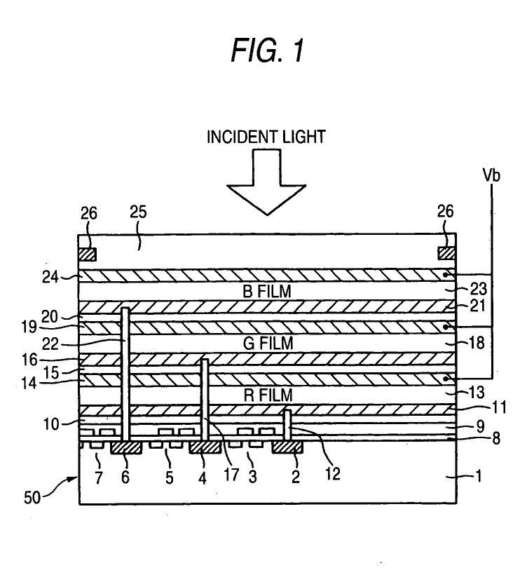

FIG. 1 is a schematic cross-sectional view showing 1 pixel of a solid-state imaging device provided by stacking a photoelectric conversion element according to an embodiment of the invention. In this embodiment, 3 photoelectric conversion elements are stacked to extract electric signals corresponding to the three primary colors of red (R), green (G), and blue (B), thereby picking up a color image. The solid-state imaging device of the invention may have only one photoelectric conversion element to pick a unicolor or monochrome image.

In FIG. 1, a high-concentration impurity region 2 for red signal accumulation, an MOS circuit 3 for red signal readout, a high-concentration impurity region 4 for green signal accumulation, an MOS circuit 5 for green signal readout, a high-concentration impurity region 6 for blue signal accumulation, and an MOS circuit 7 for blue signal readout are formed on the surface of a P well layer 1 disposed on an n-silicon substrate 50.

Each of the MOS circuits 3, 5, and 7 comprises a source impurity region and a drain impurity region formed on the semiconductor substrate, and a gate electrode formed on a gate insulating film 8. An insulating film 9 is stacked on the gate insulating film 8 and the gate electrodes to make a flat surface. A light shielding film may be formed on the insulating film 9. In this case, another insulating film 10 is further stacked to insulate the light shielding film because the light shielding film is generally a thin metal film. When the light shielding film is not disposed at this position, the insulating films 9 and 10 shown in the drawing may be integrated.

Signal charges are accumulated in the high-concentration impurity regions 2, 4, and 6, read out by the MOS circuits 3, 5, and 7, and extracted outside by a readout electrode formed on the semiconductor substrate, though the readout electrode is not shown. This structure may be equal to those of related art CMOS image sensors.

Though the signal charges are read out by the MOS circuits formed on the semiconductor substrate in this embodiment, the charges accumulated in the high-concentration impurity regions 2, 4, and 6 may be transferred along a vertical transfer path and read out along a horizontal transfer path in the same manner as related art CCD image sensors.

The above structure is produced by a semiconductor process for the related art CCD and CMOS image sensors, and the following components are added to the structure to produce the solid-state imaging device provided by stacking a photoelectric conversion element.

A transparent electrode film 11 is formed on the insulating film 10 shown in FIG. 1. The transparent electrode film 11 is connected to the high-concentration impurity region 2 for red signal accumulation by an electrode 12. The electrode 12 is electrically isolated from components other than the transparent electrode film 11 and the high-concentration impurity region 2. Further, a red detecting photoelectric conversion element 13 is formed on the transparent electrode film 11, and a transparent electrode film 14 is formed thereon. Thus, the photoelectric conversion element 13 is sandwiched between a pair of the transparent electrode films 11 and 14. The undermost layer of the electrode film 11 may be opaque to act also as a light shielding film.

A transparent insulating film 15 is formed on the transparent electrode film 14, and a transparent electrode film 16 is formed thereon. The transparent electrode film 16 is connected to the high-concentration impurity region 4 for green signal accumulation by an electrode 17. The electrode 17 is electrically isolated from components other than the transparent electrode film 16 and the high-concentration impurity region 4. Further, a green detecting photoelectric conversion element 18 is formed on the transparent electrode film 16, and a transparent electrode film 19 is formed thereon. Thus, the photoelectric conversion element 18 is sandwiched between a pair of the transparent electrode films 16 and 19.

A transparent insulating film 20 is formed on the transparent electrode film 19, and a transparent electrode film 21 is formed thereon. The transparent electrode film 21 is connected to the high-concentration impurity region 6 for blue signal accumulation by an electrode 22. The electrode 22 is electrically isolated from components other than the transparent electrode film 21 and the high-concentration impurity region 6. Further, a blue detecting photoelectric conversion element 23 is formed on the transparent electrode film 21, and a transparent electrode film 24 is formed thereon. Thus, the photoelectric conversion element 23 is sandwiched between a pair of the transparent electrode films 21 and 24.

A transparent insulating film 25 is formed as the uppermost layer, and in this embodiment, a light shielding film 26 for limiting the region of light incidence into the pixel is formed in the transparent insulating film 25. The light shielding film 26 is used in the uppermost layer to further reduce the color mixing between pixels. The uniform transparent electrode films include thin films of tin oxide (SnO₂), titanium oxide (TiO₂), indium oxide (InO₂), or indium tin oxide (ITO), though not restrictive. The transparent electrode films may be formed by laser ablation, sputtering, etc.

The photoelectric conversion elements 23, 18, and 13 have basically the same structures, and have different sizes of CdSe quantum dots. The blue detecting photoelectric conversion element 23 has the smallest CdSe quantum dot size, the green detecting photoelectric conversion element 18 has the middle CdSe quantum dot size, and the red detecting photoelectric conversion element 13 has the largest CdSe quantum dot size. The dots have sizes of nanometer order.

It is preferred that, for example, the CdSe quantum dots in the blue detecting film has an average diameter of 1.7 to 2.5 nm, the CdSe quantum dots in the green detecting film has an average diameter of 2.5 to 4 nm, and the CdSe quantum dots in the red detecting film has an average diameter of 4 to 8 nm.

The average diameters are selected such that the quantum dots have larger light absorption at the corresponding wavelength to generate a larger number of electron-hole pairs. Thus, the average diameters are selected such that the blue detecting photoelectric conversion element 23 has an absorption maximum within a wavelength range of 420 to 500 nm, the green detecting photoelectric conversion element 18 has an absorption maximum within a wavelength range of 500 to 580 nm, and the red detecting photoelectric conversion element 13 has an absorption maximum within a wavelength range of 580 to 660 nm.

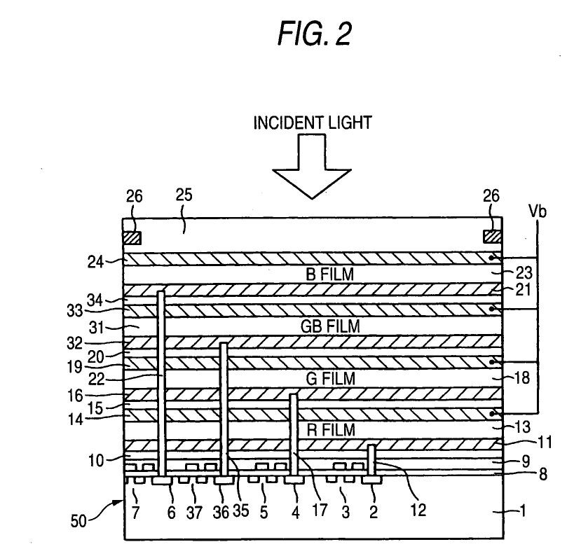

The solid-state imaging device provided by stacking a photoelectric conversion element shown in FIG. 1 is an example of detecting the three primary colors of red, green, and blue, and the solid-state imaging device of the invention may have a structure for detecting four colors. FIG. 2 is a schematic cross-sectional view showing 1 pixel of a solid-state imaging device provided by stacking a photoelectric conversion element for detecting four colors. In FIG. 2, a photoelectric conversion element 31 for detecting an intermediate color (GB, emerald color) of green (G) and blue (B) is sandwiched between transparent electrodes 32 and 33 and disposed between a green detecting film and a blue detecting film. Thus, the photoelectric conversion elements 23, 31, 18, and 13 are disposed from the top in the increasing order of the light wavelength to be detected.

In this example, the average diameters of the quantum dots are determined such that the photoelectric conversion element 23 has an absorption maximum within a wavelength range of 420 to 480 nm, the photoelectric conversion element 31 has an absorption maximum within a wavelength range of 480 to 520 nm, the photoelectric conversion element 18 has an absorption maximum within a wavelength range of 520 to 580 nm, and the photoelectric conversion element 13 has an absorption maximum within a wavelength range of 580 to 660 nm.

Further, a high-concentration impurity region 36 for intermediate color signal accumulation is formed on the semiconductor substrate. An electrode 35 connects the high-concentration impurity region 36 and the transparent electrode 32, and is electrically isolated from other components. An MOS circuit 37 for reading signal charges in the high-concentration impurity region 36 is formed on the semiconductor substrate. A transparent insulating film 34 is formed between the transparent electrode film 33 and the upper transparent electrode film 21 as a matter of course.

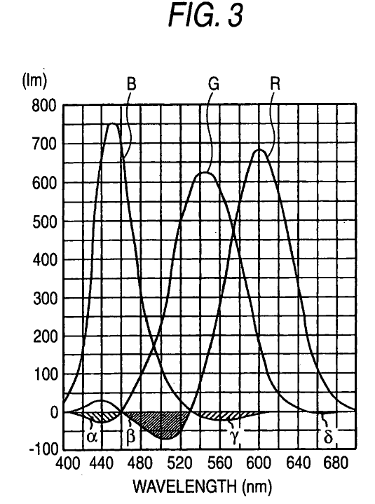

The solid-state imaging device capable of detecting the intermediate color with a wavelength of 480 to 520 nm is advantageous in correcting the red color according to human visibility. The human visibility includes negative sensitivities in the regions of green (G), red (R), and blue (B) as shown by α, β, and γ in FIG. 3. Therefore, when only positive components of R, G, and B are detected by the solid-state imaging device to reproduce the colors, an image that human eye detects cannot be reproduced. The human red sensitivity can be achieved in the solid-state imaging device such that the largest negative component β of red is detected by the photoelectric conversion element 31, and a signal processing of subtracting the negative component from red components detected by the photoelectric conversion element 13 is carried out in the same manner as Japanese Patent No. 2,872,759.

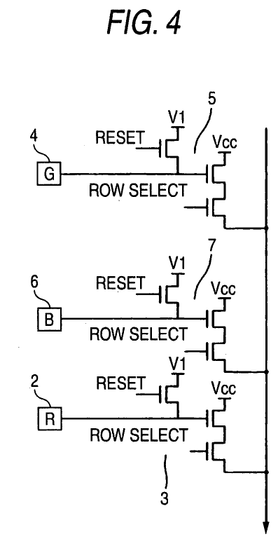

FIG. 4 is a schematic circuit diagram of the MOS circuits 3, 5, and 7 of FIG. 1. The MOS circuits comprise 3 FET devices for each of R, G, and B, and have a circuit structure equal to those of related art CMOS image sensors. In the case of the solid-state imaging device of FIG. 2, only 3 FET devices for the intermediate color (GB) are added per 1 pixel.

In the related art CMOS image sensors, photoreceivers are formed on the semiconductor surface, whereby MOS circuits have to be formed in a small area of the semiconductor surface to widen the photoreceiver area. On the contrary, the solid-state imaging device provided by stacking a photoelectric conversion element of this embodiment requires no photoreceivers on the semiconductor surface, whereby the MOS circuits can be easily formed. Further, the solid-state imaging device has a larger space for a wiring, so that it is easy to form a wiring for simultaneously reading R, G, and B, though R, G, and B are sequentially read in FIG. 4 while selecting one of them by a select signal. This is applicable not only to the MOS circuits but also to readout circuits with charge transfer paths of CCD image sensors, etc.

FIGS. 1 and 2 show the structure of 1 pixel respectively. Such pixels are formed into an array on the semiconductor substrate. The photoelectric conversion element does not need to be divided according to each pixel. A sheet of the photoelectric conversion element may be stacked on the entire surface of the semiconductor substrate, and the pixels can be formed by separating one of the transparent electrodes sandwiching the photoelectric conversion element into the form of the pixels.

When a light is injected from a subject into the solid-state imaging device provided by stacking a photoelectric conversion element of FIG. 1 or 2, blue components of the incident light are absorbed by the photoelectric conversion element 23, green components are absorbed by the photoelectric conversion element 18, and red components are absorbed by the photoelectric conversion element 13. Further, in the case of the solid-state imaging device of FIG. 2, emerald components of the intermediate color (GB) are absorbed by the photoelectric conversion element 31.

The quantum dots (the ultrafine particles) of the photoelectric conversion element 23 absorb the incident light to generate electron-hole pairs. Though the electron-hole pairs are recombined to emit a blue light after a certain period of time, by applying a voltage to the transparent electrodes 24 and 21, electrons of the pairs are transferred from the transparent electrodes 21 through the electrode 22 to the high-concentration impurity region 6 before the recombination.

In the same manner, electrons generated in the photoelectric conversion element 18 according to the incident green light quantity are transferred to the high-concentration impurity region 4, electrons generated in the photoelectric conversion element 13 according to the incident red light quantity are transferred to the high-concentration impurity region 2, and electrons generated according to the incident emerald light quantity are transferred to the high-concentration impurity region 36 (FIG. 2). Then, the electrons corresponding to each color are read out by the MOS circuits 3, 5, 7, and 37.

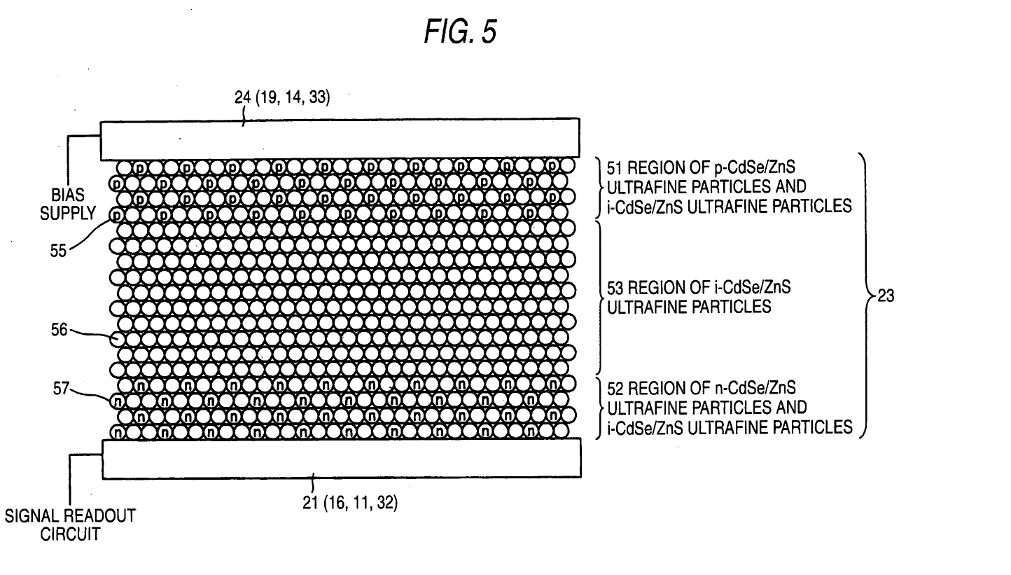

FIG. 5 is a schematic cross-sectional view showing the photoelectric conversion elements 23, 18, 13, and 31. In the shown example, the photoelectric conversion element 23, which is disposed between the transparent electrode films 24 and 21, comprises a p layer region 51 in the electrode 24 side, an n layer region 52 in the electrode 21 side, and an i layer region 53 provided therebetween. The photoelectric conversion elements 18, 13, and 31 have the same structure as the film 23 except for the quantum dot sizes.

In the p layer region 51, p-conductive quantum dots 55 provided by covering a core of a p-conductive ultrafine CdSe particle with ZnS are mixed with i-conductive quantum dots 56 provided by covering a core of an i-conductive ultrafine CdSe particle with ZnS at a certain ratio.

In the i layer region 53, the i-conductive quantum dots 56 provided by covering a core of an i-conductive ultrafine CdSe particle with ZnS are accumulated.

In the n layer region 52, n-conductive quantum dots 57 provided by covering a core of an n-conductive ultrafine CdSe particle with ZnS are mixed with the i-conductive quantum dots 56 provided by covering a core of an i-conductive ultrafine CdSe particle with ZnS at a certain ratio.

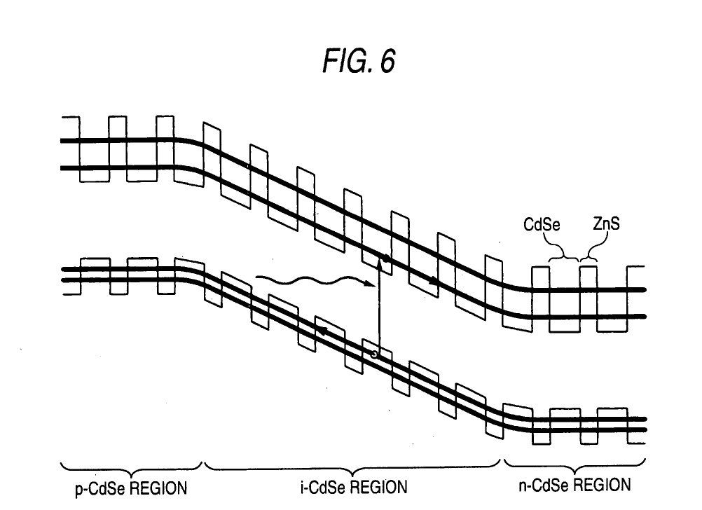

FIG. 6 is a schematic view showing an ideal energy band assumed from the structure of FIG. 5. The CdSe quantum dots in the ultrafine particles are arranged at a remarkably small distance with the ZnS shells between, whereby a discrete level is produced in a CdSe particle due to the quantum confinement effect and interacts with a discrete level of the adjacent CdSe particle to form a miniband.

In the i layer region 53, a potential gradient is generated by the diffusion potential of the junction between the p-layer 51, the i-layer 53, and the n-layer 52 of the photoelectric conversion element 23 (the macroscopic p-i-n junction) and by a reverse bias voltage applied by an external power source, and electrons and holes generated in the CdSe particles by light incidence undergo charge separation through the miniband.

In view of forming the miniband, the distance between adjacent CdSe quantum dots (the sum of the thicknesses of the ZnS shell and an organic molecule layer between the CdSe quantum dots) is preferably 0.3 to 5 nm, more preferably 0.3 to 2 nm. As the distance is increased, the electric conductivity is remarkably lowered during the carrier generation by light incidence, so that larger reverse bias voltage is required, thereby resulting in larger noise.

Though the macroscopic p-i-n junction is formed in the above embodiment, a macroscopic p-n junction may be formed by removing the i layer region 53 to generate the electric potential gradient. It is more preferred that the i layer region 53 be provided between the p layer region 51 and the n layer region 53 to control the electric potential gradient.

Production of the ultrafine CdSe particles is described in detail in B. O. Dabbousi, et al., Journal of American Chemical Society, Vol. 115, 8706-8715 (1993), etc., and methods for covering the CdSe particles with ZnS are described in detail in C. B. Murray, et al., Journal of Physical Chemistry, Vol. 101, 9463-9475 (1997), etc.

For example, a solution prepared by dissolving dimethylcadmium in trioctylphosphine (TOP) and a solution prepared by dissolving trioctylphosphine selenide (TOPSe) in TOP are mixed and added to trioctylphosphine oxide (TOPO) heated at approximately 300° C.

Then, the sizes of the ultrafine CdSe particles are controlled by changing heating time and temperature, and the solution is added to methanol and centrifuged to further classify.

After the classification, the residue is dispersed in hexane, and the obtained liquid is added to a solution of TOPO and TOP, and heated. A solution prepared by dissolving diethylzinc in TOP and a solution prepared by dissolving hexamethyldisilathiane in TOP are added to the liquid to produce the CdSe/ZnS particles.

The temperatures and amounts are controlled depending on the sizes of the ultrafine CdSe particles and the desired thickness of ZnS coating. Thus-obtained ultrafine particle dispersion is added to methanol and centrifuged, and is redispersed in an organic solvent such as hexane.

Further, to obtain the n-CdSe/ZnS particles used in this embodiment, as described in Dong Yu, et al., Science, Vol. 300, 1277-1280 (2003), etc., the prepared ultrafine CdSe particles are dried, potassium is deposited thereonto under ultrahigh vacuum, and electrons are injected from the potassium atoms. The electrons do not need to be injected into all the ultrafine particles, and the n-CdSe/ZnS particles may be mixed with the i-CdSe/ZnS particles locally. Even in a case where the ratio of the ultrafine particles injected with electrons is extremely small, the diffusion is caused through the miniband and the ultrafine particles can be considered as n-particles macroscopically.

To obtain the p-CdSe/ZnS particles, holes are injected by attaching chlorine radicals generated by plasma arc. Also in this case, the ultrafine p-CdSe/ZnS particles may be mixed with the ultrafine i-CdSe/ZnS particles locally in the same manner as the n-particles.

The obtained ultrafine n-, i-, and p-particles are deposited in this order on the transparent electrode 21 (see FIG. 5) by a doctor blade method, and then heat-treated. The transparent electrode 24 is stacked on the obtained photoelectric conversion element 23 with the p-i-n junction by sputtering. An organic molecule layer with a thickness of 3 nm or less may remain between the ultrafine CdSe/ZnS particles.

Though the ultrafine CdSe/ZnS particles prepared in a liquid are used in the embodiment, the production processes and types of the particles are not limited thereto. For example, a macroscopic n-CdSe layer is formed on a ZnS substrate in vacuum by using lattice distortion. In the early stage of the formation of the CdSe layer, the CdSe is not in the form of a film and grows into a separated island structure. Thus, the formation of the CdSe layer is stopped in this stage, and ZnS is buried within the island structure. Then, in the same manner, an i-CdSe layer is formed by burying ZnS within an island structure, and a p-CdSe layer is formed by burying ZnS within an island structure. The photoelectric conversion element 23 may be produced by repeating these steps.

Ultrafine semiconductor particles comprising a core of InN and a shell of GaN may be used instead of the CdSe/ZnS particles. Further, ultrafine semiconductor particles comprising a core of ZnTe and a shell of ZnS may be used.

In a case where the photoelectric conversion element 23 formed in the above manner is used for converting a blue light, the thickness of the film is preferably such that the film can sufficiently absorb the blue light to prevent the blue light incidence into the next photoelectric conversion element. When the blue light is injected into the next photoelectric conversion element for a green light and causes photoexcitation, the color separation properties are deteriorated. The blue light transmittance of the photoelectric conversion element for the blue light is an intrinsic property. Thus, even when the blue light is injected into the next green light conversion film, the change of green signals due to the blue light can be estimated from the signals of the blue light conversion film, and the green signals can be corrected by signal calculation.

The signal charges may be transferred from each of the photoelectric conversion elements of FIGS. 1 and 2 to the corresponding high-concentration impurity region 2, etc. according to methods of extracting signals from light receiving elements of common CCD and CMOS image sensors. For example, a certain amount of bias charges are injected into the high-concentration impurity region 2, etc. (the accumulation diode) in a refresh mode, the electric charges by light incidence are accumulated in photoelectric conversion mode, and then the signal charges are read out. The photoelectric conversion element per se may be used as an accumulation diode, and the film may be equipped with an accumulation diode additionally.

The signal charges transferred to the high-concentration impurity region 2, etc. may be read out by readout methods for common CCD and CMOS image sensors.

Related art solid-state imaging devices such as CCD devices comprise a light receiving element having a photoelectric conversion function, an accumulation unit for accumulating converted signals, a readout unit for reading the accumulated signals, a unit for selecting positions of pixels, etc. A light is photoelectrically converted to signal charges or signal current in the photoreceiver, and is accumulated in the photoreceiver or a capacitor attached. The accumulated charges are read out by a so-called charge-coupled device (CCD), an X-Y address type MOS imaging device (a so-called CMOS sensor), etc. while selecting the pixel positions.

The CCD image sensors may have a charge transfer part for transferring the charge signals of the pixels to an analog shift register by a transfer switch, and the signals may be read out by the register to an output terminal sequentially. The CCD image sensors include line address type, frame transfer type, interline transfer type, and frame interline transfer type sensors. Further, the CCD may have a 2-phase structure, a 3-phase structure, a 4-phase structure, a buried channel structure, etc., and the solid-state imaging device provided by stacking a photoelectric conversion element of the invention may have a vertical transfer path with any one of the structures.

The solid-state imaging device of the invention may be an address selection type device where each pixel is selected by a multiplexer switch and a digital shift register sequentially, and signal voltages (or charges) are read out to a common output line. A two-dimensionally arrayed X-Y address scanning type imaging device is known as a CMOS sensor. In this device, a switch is disposed on a pixel connected to an X-Y intersection point, and the switch is connected to a vertical shift register. When the switch is turned on by voltage from the vertical scanning shift register, signals from pixels in the same row are read out to an output line in a column. The signals are read out from an output terminal sequentially through a switch, which is driven by a horizontal scanning shift register.

The output signals may be read by a floating diffusion detector or a floating gate detector. The S/N ratio may be improved by forming a signal amplifier circuit in a pixel portion, correlated double sampling, etc.

The signals may be modified by gamma correction using an ADC circuit, digitization using an AD converter, luminance signal processing, or color signal processing. The color signal processing includes white balance processing, color separation processing, color matrix processing, etc. In the case of using NTSC signals, RGB signals may be converted to YIQ signals in the same manner as related art CCD and CMOS image sensors.

Though microlenses, infrared cut filters, and ultraviolet cut filters are not explained in the above embodiment, in the structure of FIG. 1 or 2, an infrared cut filter may be disposed in the undermost layer or the uppermost layer, and a microlens may be used to increase light concentration. Further, an ultraviolet cut filter may be disposed in the uppermost layer or between a lens and the photoelectric conversion element.

In the embodiment, the solid-state imaging device provided by stacking a photoelectric conversion element comprises 3 or 4 photoelectric conversion elements to have various advantages. For example, the solid-state imaging device can form an image free of moire, the device can detect R, G, and B components simultaneously in one pixel without an optical lowpass filter to show high resolution, the device can achieve excellent resolution of brightness and colors with no blurring, the device uses simple signal processing and generates no pseudo-signals to show excellent reproducibility of hair, etc., the pixels of the device can be mixed easily and can be partially read out easily, the device has the aperture ratio of 100% without a microlens, and the device has no restrictions on the eye point distance to the image pickup lens to cause no shading, thereby being suitable for lens interchangeable cameras and capable of using a thinner lens. Thus, the solid-state imaging device of the invention overcomes disadvantages of the related art CCD and CMOS image sensors.

1. A solid-state imaging device comprising:
a signal readout circuit for reading out an signal;
a semiconductor substrate having the signal readout circuit; and
a photoelectric conversion element stacked on the semiconductor substrate for photoelectrically converting an incident light, comprising: a first deposition layer comprising a p-conductive quantum dot and an i-conductive quantum dot; and the second deposition layer comprising an n-conductive quantum dot and an i-conductive quantum dot,
wherein the signal is based on a quantity of the incident light photoelectrically converted by the photoelectric conversion element.

2. The solid-state imaging device according to claim 1, wherein the photoelectric conversion element further comprises a third deposition layer comprising the i-conductive quantum dot without the p-conductive quantum dot and the n-conductive quantum dot between the first deposition layer and the second deposition layer.

3. The solid-state imaging device according to claim 1, wherein each of the quantum dots comprises an ultrafine semiconductor particle as a core and a material covering the core, and an optical bandgap energy of the material is larger than that of the ultrafine semiconductor particle.

4. The solid-state imaging device according to claim 3, wherein the ultrafine semiconductor particle comprises CdSe, and the material comprises ZnS.

5. The solid-state imaging device according to claim 3, wherein the ultrafine semiconductor particle comprises ZnTe, and the material comprises ZnS.

6. The solid-state imaging device according to claim 3, wherein the ultrafine semiconductor particle comprises InN, and the material comprises GaN.

7. The solid-state imaging device according to claim 1, wherein
the solid-state imaging device comprises a first photoelectric conversion element, a second photoelectric conversion element, and a third photoelectric conversion element, and
the photoelectric conversion elements are sandwiched between the two transparent electrodes respectively and are stacked with intermediate transparent insulating films.

8. The solid-state imaging device according to claim 7, wherein an average diameter of the quantum dots in each of the photoelectric conversion elements is determined such that
the first photoelectric conversion element has an absorption maximum within a wavelength range of 420 to 500 nm,
the second photoelectric conversion element has an absorption maximum within a wavelength range of 500 to 580 nm, and
the third photoelectric conversion element has an absorption maximum within a wavelength range of 580 to 660 nm.

9. The solid-state imaging device according to claim 1, wherein the solid-state imaging device comprises a first photoelectric conversion element, a second photoelectric conversion element, a third photoelectric conversion element, and a fourth photoelectric conversion element, and
the photoelectric conversion elements are sandwiched between the two transparent electrodes respectively and are stacked with intermediate transparent insulating films.

10. The solid-state imaging device according to claim 9, wherein an average diameter of the quantum dots in each of the photoelectric conversion elements is determined such that
the first photoelectric conversion element has an absorption maximum within a wavelength range of 420 to 480 nm,
the second photoelectric conversion element has an absorption maximum within a wavelength range of 480 to 520 nm,
the third photoelectric conversion element has an absorption maximum within a wavelength range of 520 to 580 nm, and
the fourth photoelectric conversion element has an absorption maximum within a wavelength range of 580 to 660 nm.
